(19) United States
(12) Patent Application Publication
(10) Pub. No.: US 2023/0415446 A1
(43) Pub. Date: Dec. 28, 2023

(54) MULTILAYER STRUCTURE FOR TRANSPORTING OR STORING HYDROGEN

(71) Applicant: ARKEMA FRANCE, Colombes (FR)

(72) Inventors: Gilles HOCHSTETTER, Colombes Cedex (FR); Thibaut SAVART, Lacq (FR); Patrick DANG, Serquigny (FR); Richard AUDRY, Colombes Cedex (FR)

(73) Assignee: ARKEMA FRANCE, Colombes (FR)

(21) Appl. No.: 18/253,995

(22) PCT Filed: Nov. 22, 2021
(86) PCT No.: PCT/FR2021/052052

§ 371 Date: May 23, 2023

(30) Foreign Application Priority Data
Nov. 24, 2020 (FR) FR2012046

(51) Int. Cl. B32B 1/08; B32B 5/26; B32B 37/04

(52) U.S. Cl. CPC B32B 1/08; B32B 5/26; B32B 37/04; B32B 2260/023; B32B 2260/046; B32B 2307/302; B32B 2597/00

(57) ABSTRACT

A multilayer structure which is chosen from among a tank, a pipe or a tube and intended for transporting, distributing or storing liquid hydrogen, the structure including a sealing layer in contact with the liquid hydrogen, the sealing layer including a composition which includes a polymer P1 which is polychlorotrifluoroethylene and at least one second layer located above the sealing layer, the second layer being a composite reinforcing layer of a fibrous material in the form of continuous fibers impregnated with a composition mainly including at least one thermoplastic or thermosetting polymer P2.

### TECHNICAL FIELD

The present patent application relates to multilayer composite structures for transporting, distributing, or storing liquid hydrogen and the method for making them.

### PRIOR ART

One of the aims sought in various fields such as the automotive field and the aircraft field is to propose less and less polluting transportation.

Thus, electric or hybrid vehicles comprising a battery aim to progressively replace combustion engine vehicles such as either gas or diesel vehicles. It has turned out that the battery is a relatively complex vehicle component. Depending on the positioning of the battery in the vehicle, it may be necessary to protect it from impact and from the outside environment, which can have extreme temperatures and variable humidity. It is also necessary to avoid any risk of flames.

Additionally, it is important that the operating temperature thereof not exceed 55° C. in order to not break down the cells of the battery and to preserve the life thereof. Conversely, for example in winter, it may be necessary to increase the battery temperature so as to optimize operation thereof.

However, electric vehicles still suffer today from several problems, namely battery range, the use in these batteries of rare earths whose resources are not inexhaustible, as well as a problem of electricity production in various countries to be able to recharge the batteries.

Furthermore, the use of batteries in aircraft is currently limited to flying machines of very small capacity and therefore to transporting a small number of passengers over distances of no more than 500 km and is not yet suitable for medium or large aircraft.

Hydrogen is therefore an alternative to the electric battery, since hydrogen can be converted into energy to power a motor by means of a fuel cell and thus to power electric vehicles, electric aircraft, or electric trains. It can also be used without an intermediate fuel cell, in particular in aircraft or in spacecraft (rockets) by direct injection into the engine and thus supply the energy necessary for its operation. Nevertheless, hydrogen storage is technically difficult and costly due to its very low molar mass.

Additionally, to be effective, storage must be carried out in small volumes, which means that the hydrogen must be kept under high pressure, given the temperatures at which vehicles are used. This is the case, in particular, for fuel cell hybrid road vehicles for which the goal is a range of around 600 to 700 km, or even less, for essentially urban use in addition to a battery-powered electric base. However, this type of storage does not offer sufficient volume to be able to fly an airplane or pull a train with a locomotive.

One of the solutions that has arisen in such cases is to store liquid hydrogen. but its very low liquefaction temperature (−253° C. or 20.28° K) requires materials capable of withstanding such temperatures, particularly when it is moving storage.

Pressurized hydrogen tanks are usually made of a metallic liner that must prevent hydrogen from leaking out. This first liner must itself be protected by a second liner usually made of composite materials) designed to withstand the internal pressure of the tank (e.g. 700 bar) and to withstand any impact or heat sources. The valve system must also be safe.

According to the French Hydrogen and Fuel Cell Association (AFHYPAC) Hydrogen Memento Sheet 4.2, December 2016 revision, pressurized hydrogen storage and distribution has been standard practice for very many years with cylindrical, steel cylinders or cylinder assemblies inflated to 20 or 25 MPa (Types I and II). The disadvantage of this storage method is the size—only 14 kg/m³ of hydrogen at 20 MPa of pressure and at ordinary temperature (21° C.) compared to 100 kg/m³ for methane under the same storage conditions—and above all the weight, which results from the use of low-stress steels to avoid hydrogen embrittlement problems. The situation has radically changed with the appearance of what are called type IV or V composite tanks. Their basic principle is to separate the two essential functions of sealing and mechanical strength and manage them independently of each other. In this type of reservoir, a bladder made of resin (thermosetting or thermoplastic), also known as a liner (or sealing sheath), is combined with a reinforcing structure consisting of fibers (glass, aramid, carbon), also known as a reinforcing layer or sleeve, which allows the reservoir to operate at much higher pressures while reducing its mass and avoiding the risk of explosive rupture in the event of severe external aggression. Thus, 70 MPa (700 bar) has practically become the current standard for gas storage such as hydrogen.

In type IV tanks, the liner and the reinforcing layer consist of different materials, which has the disadvantage of being reflected by a lack of adhesion between the liner and the reinforcing layer.

Type V tanks have recently appeared, which are based on using the same polymer for the liner and the composite matrix in order to guarantee excellent and durable adhesion between the liner and the composite.

When transporting or distributing hydrogen by means of rigid or flexible pipes, it is also preferable that the hydrogen is at a low volume to ensure sufficient flow. Thus, as with storing, transporting, or distributing hydrogen, it is interesting to use composite pipes composed of a sealing sheath (ensuring airtightness and chemical resistance), reinforced by an outer layer made of composite material, which is manufactured by filament winding, from unidirectional (UD) tapes deposited in successive layers on the liner. When it is desired to make this pipe flexible, one possibility is to wind the UD tape with one or more angles of orientation with respect to the axis of the pipe so that the composite reinforcement can support the deformations of the composite pipe during its use. The composite reinforcement allows the pipe to withstand the internal pressure generated by the fluid being transported.

In addition, the sealing sheath must be able to be extruded continuously, possibly on the support of an internal carcass or wound onto said support. This sealing sheath must be sufficiently chemically stable so that its mechanical and sealing characteristics do not deteriorate in a way that would be prohibitive during the life of the reservoir or flexible pipe.

In the case of a flexible pipe with an internal metallic carcass, the sealing liner must also be able to withstand the effect of creep of the material it is made of, due to the stresses generated on the sealing sheath by the internal pressure of the pipe. Creep occurs in the joints (gap or clearance) between the metallic armoring (e.g. self-clinching zeta or T geometry) on which the liner rests when the pipe is pressurized by the effluent being transported, creating protrusions of material which generate stress concentrations and are therefore preferred failure zones for the sealing sheath: the material making up the sealing sheath must therefore also withstand these stress concentrations

Thus, there is still a need to optimize, on the one hand, the matrix of the composite so as to optimize its mechanical strength at high temperature and, on the other hand, the material composing the sealing sheath, so as to withstand very low temperatures.

These problems are solved by providing a multilayer structure of the present invention.

Throughout this description, the terms “liner”, “sealing sheath” and “pressure jacket” have the same meaning.

The present invention therefore relates to a multilayer structure which is chosen from among a tank, a pipe or a tube and intended for transporting, distributing or storing liquid hydrogen, the structure comprising a sealing layer (1) in contact with the liquid hydrogen, the sealing layer comprising a composition which comprises a polymer P1 which is polychlorotrifluoroethylene (PCTFE) and at least one second layer (2) located above the sealing layer,
the second layer (2) being a composite reinforcing layer consisting of a fibrous material in the form of continuous fibers impregnated with a composition mainly comprising at least one thermoplastic or thermosetting polymer P2.

By “multilayer structure” is meant, for example, a tank, pipe or tube, comprising or consisting of several layers, in particular two layers.

The sealing layer is the innermost layer compared to the composite reinforcement layers, which are the outermost layers.

The sealing layer is in contact with the hydrogen even if an inner, and thus innermost, non-sealing metallic layer, formed by a helically wound profiled metal strip such as a stapled metallic strip to form said carcass, is present on which the sealing layer(s) is (are) coated by extrusion, the extrusion being performed by depositing pre-fabricated composite or polymer films or using a continuous extruder, for instance.

When only a sealing layer and a composite reinforcing layer are present, thus leading to a two-layer multilayer structure, then those two layers may be welded and thus may adhere to each other, in direct contact with each other.

Advantageously, they are welded and therefore adhere to each other, in direct contact with one another.

When several composite reinforcing layers are present, then the sealing layer can be welded to the innermost layer of said composite reinforcement, and therefore can adhere to one another, in direct contact with one another.

Advantageously, the sealing layer is welded to the innermost layer of said composite reinforcement, and therefore adhere to each other, in direct contact with one another. The other composite reinforcing layers may also be welded together.

The inventors have therefore found, unexpectedly, that the use of a sealing layer comprising a composition comprising PCTFE with at least one composite reinforcing layer comprising a thermoplastic or thermosetting polymer made it possible, whether or not the sealing layer is welded to the innermost layer of the composite reinforcing layers, to obtain a multilayer structure as defined that is capable of transporting, distributing or storing liquid hydrogen.

In one embodiment, the multilayer structure of the invention is devoid of an intermediate layer made of PCTFE co-molded with a base when it is present and the sealing layer.

### Regarding the Sealing Layer (1)

PCTFE denotes a polymer comprising predominantly CTFE units. It may be a homopolymer of CTFE or a copolymer of CTFE and of at least one other monomer copolymerizable with CTFE comprising by weight at least 75%, advantageously at least 85%, preferably at least 95% of CTFE. A comonomer that can be used is, for example, vinylidene fluoride (VDF).

The PCTFE of the invention is in the form of a thermoplastic polymer advantageously having a ZST between 200 and 450 s, preferably between 300 and 450 s. ZST (Zero Strength Time) is defined in ASTM D-1430 to characterize the molecular mass of PCTFE. By way of example of commercial PCTFE, the NEOFLON® M-300P or M-400H grades from the company DAIKIN or the VOLTALEF® 302 company from the company ARKEMA may be used.

The term “predominantly” means that said polymer P1, being PCTFE, is present in excess of 50% by weight relative to the total weight of the composition.

Advantageously, said at least predominant PCTFE is present at more than 60% by weight, especially at more than 70% by weight, particularly at more than 80% by weight, more particularly greater than or equal to 90% by weight, relative to the total weight of the composition.

### It is Quite Obvious

Said composition may further comprise impact modifiers and/or additives. The additives may be chosen from an antioxidant, a heat stabilizer, a UV absorber, a light stabilizer, a lubricant, an inorganic filler, a flame retardant agent, a nucleating agent, a plasticizer, and a dye.

Advantageously, said composition of the layer (1) consists of said predominant polymer PCTFE in at least 90% by weight, from 0 to 5% by weight of impact modifier, from 0 to 5% by weight of additives, the sum of the constituents of the composition being equal to 100%.

Advantageously, said composition of the layer (1) consists of said predominant polymer PCTFE in at least 90% by weight, from 1 to 5% by weight of impact modifier, from 0.1 to 5% by weight of additives, the sum of the constituents of the composition being equal to 100%.

Two variants are possible for said sealing layer (1).

In a first variant, said sealing layer (1) is made up of a fibrous material in the form of continuous fibers impregnated with a composition predominantly comprising a polymer P1 being polychlorotrifluoroethylene (PCTFE) and at least one of said innermost composite reinforcing layers consisting of a fibrous material in the form of continuous fibers impregnated with a composition predominantly comprising at least one thermoplastic polymer which is PCTFE. Advantageously, the fibrous material of the sealing layer (1) and the composite reinforcing layer (2) is the same, in particular carbon fibers.

Advantageously, all the composite reinforcing layers (2) consist of a fibrous material in the form of continuous fibers impregnated with a composition predominantly comprising at least one thermoplastic polymer P1 which is PCTFE. Advantageously, the fibrous material of the sealing layer (1) and the composite reinforcing layer (2) is the same, in particular carbon fibers, and all the composite reinforcing layers (2) are made of a fibrous material in the form of continuous fibers impregnated with a composition predominantly comprising at least one thermoplastic polymer which is PCTFE.

The sealing layer (1) is therefore identical to said composite reinforcing layers (2).

Advantageously, said sealing layer (1) is welded to the innermost composite reinforcing layer (2).

Advantageously, all the composite reinforcing layers (2) are welded together.

In a second variant, said innermost composite reinforcing layer (2) is wound around said sealing layer (1),

said sealing layer (1) consisting of a composition predominantly comprising polychlorotrifluoroethylene (PCTFE),

and at least one of said innermost composite reinforcing layers consisting of a fibrous material in the form of continuous fibers impregnated with a composition predominantly comprising at least one thermoplastic or thermosetting polymer.

Said sealing layer, unlike the first variant, is therefore devoid of fibrous material.

### Regarding the Reinforcing Layer (2)

One or more composite reinforcement layers may be present.

Each of said layers consists of a composition predominantly comprising at least one thermoplastic polyamide P2.

There may be from 1 to 10 reinforcing layers (2), in particular from 1 to reinforcing layers (2), in particular from 1 to 3 reinforcing layers (2).

In particular, a reinforcing layer (2) is present.

The term “predominantly” means that said at least one polymer P2 is present in excess of 50% by weight relative to the total weight of the composition.

Advantageously, said at least one predominant polymer P2 is present at more than 60% by weight, especially at more than 70% by weight, particularly at more than 80% by weight, more particularly greater than or equal to 90% by weight, relative to the total weight of the composition.

Said at least one predominant polymer P2 may be in a mixture with another polymer such as PVDF or PMMA or any other polymer miscible with PCTFE up to 20% by weight relative to the sum of said polymers.

Said composition may further comprise impact modifiers and/or additives. The additives may be chosen from an antioxidant, a heat stabilizer, a UV absorber, a light stabilizer, a lubricant, an inorganic filler, a flame retardant agent, a nucleating agent, a plasticizer, and a dye.

Advantageously, said composition predominantly consists of at least 90% of said thermoplastic polymer P2, from 0 to 5% by weight of impact modifier, from 0 to 5% by weight of additives, the sum of the constituents of the composition being equal to 100% (based on a maximum P2 of 90% by weight).

More advantageously, said composition predominantly consists of at least 90% of said thermoplastic P2, from 1 to 5% by weight of impact modifier, from 0.1 to 5% by weight of additives, the sum of the constituents of the composition being equal to 100%.

Said at least one predominant polymer in each layer may be the same or different. In one embodiment, a single predominant polymer is present at least in the composite reinforcing layer welded to the sealing layer.

In a first variant for the composite reinforcing layer (2), said polymer of said composition of said reinforcing layer (2) is a thermoplastic polymer.

### Thermoplastic Polymer P2

Thermoplastic, or thermoplastic polymer, refers to a material that is generally solid at ambient temperature, which may be semi-crystalline or amorphous, in particular semi-crystalline, and that softens during a temperature increase, in particular after passing its glass transition temperature (Tg) and flows at a higher temperature when it is amorphous, or that may exhibit a sharp transition upon passing its so-called melting point (Tm) when it is semi-crystalline, and which becomes solid again when the temperature decreases below its crystallization temperature Tc, (for a semi-crystalline) and below its glass transition temperature (for an amorphous).

The Tg, Tc, and Tm are determined by differential scanning calorimetry (DSC) according to standard 11357-2:2013 and 11357-3:2013, respectively.

The number-average molecular weight Mn of said thermoplastic polymer is preferably in a range extending from 10,000 to 40,000, preferably from 12,000 to 30,000. These Mn values may correspond to inherent viscosities greater than or equal to 0.8, as determined in m-cresol according to standard ISO 307:2007 but by changing the solvent (use of m-cresol instead of sulfuric acid and the measurement temperature being 20° C.).

As examples of semi-crystalline thermoplastic polymers which are suitable in the present invention, mention may be made of:
polyamides, in particular comprising an aromatic and/or cycloaliphatic structure, including copolymers, for example polyamide-polyether copolymers, polyesters,
polyaryletherketones (PAEK),
polyetheretherketones (PEEK),
polyetherketoneketones (PEKK),
polyetherketone etherketone ketones (PEKEKK),
polyimides, in particular polyetherimides (PEI) or polyamide-imides, polylsulfones (PSU) in particular polyarylsulfides such as polyphenyl sulfones (PPSU),
polyethersulfones (PES).
semi-crystalline polymers are more particularly preferred, and in particular polyamides and their semi-crystalline copolymers.

The nomenclature used to define polyamides is described in ISO 1874-1:2011 standard “Plastics—Polyamide (PA) Moulding and Extrusion Materials—Part 1: Désignation”, especially on page 3 (Tables 1 and 2) and is well known to the person skilled in the art.
The polyamide may be a homopolyamide or a copolyamide or amixture thereof. Advantageously, the semi-crystalline polyamides are semi-aromatic polyamides, in particular a semi-aromatic polyamide of formula X/YAr, as described in EP1505099, in particular a semi-aromatic polyamide of formula A/XT in which A is chosen from a unit obtained from an amino acid, a unit obtained from a lactam and a unit corresponding to the formula (Ca diamine). (Cb diacid), with a representing the number of carbon atoms of the diamine and b representing the number of carbon atoms of the diacid, a and b both being between 4 and 36,
advantageously between 9 and 18, the (Ca diamine) unit being chosen from linear or branched aliphatic diamines, cycloaliphatic diamines and alkylaromatic diamines and the (Cb diacid) unit being chosen from linear or branched aliphatic diacids, cycloaliphatic diacids and aromatic diacids,
X.T denotes a unit obtained from the polycondensation of a Cx diamine and terephthalic acid, with x representing the number of carbon atoms of the Cx diamine, x being between 5 and 36, advantageously between 9 and 18, especially a polyamide with formula A/5T, A/6T, A/9T, A/10T, or A/11T, A being as defined above, in particular a polyamide chosen from among a PA MPMDT/6T, a PA11/10T, a PA 5T/10T, a PA 11/BACT, a PA 11/6T/10T, a PA MXDT/10T, a PA MPMDT/10T, a PA BACT/10T, a PA BACT/6T, PA BACT/10T/6T, a PA 11/BACT/6T, PA 11/M P M DT/6T, PA 11/MP M D T/10T, PA 11/BACT/10T, a PA 11/MXDT/10T, an 11/5T/10T.

T corresponds to terephthalic acid, MXD corresponds to m-xylylene diamine, MPMD corresponds to methylpentamethylene diamine and BAC corresponds to bis(aminomethyl)cyclohexane. Said semi-aromatic polyamids defined above particularly have a Tg greater than or equal to 80° C.

Advantageously, each composite reinforcing layer consists of a composition comprising the same type of polymer, in particular a polyamide.

Advantageously, said composition comprising said polymer P2 is transparent to radiation suitable for welding.

Thermoplastic polymers are generally transparent for welding purposes, especially laser welding. Carbonaceous nanofillers make it possible to impart a black color to a layer of a composition comprising a thermoplastic polymer, while maintaining the transparency to laser radiation of said layer.

Advantageously, the carbonaceous nanofillers are non-agglomerated or non-aggregated. Advantageously, the carbonaceous nanofillers are incorporated into the composition in an amount from 100 ppm to 500 ppm, and preferably from 250 ppm to 500 ppm.

Advantageously, the carbonaceous nanofillers are selected from carbon nanotubes (CNTs), carbon nanofibers, graphene, nanoscale carbon black and mixtures thereof.

Advantageously, the carbonaceous nanofillers are free of nanometric carbon black.

In one embodiment, the welding is performed by a system selected from laser, IR heating or induction heating.

Advantageously, the welding is performed by a laser system.

Advantageously, the laser radiation is infrared laser radiation, and preferably has a wavelength between 700 nm and 1200 nm and preferably between 800 nm and 1100 nm.

In a second variant for the composite reinforcing layer (2), said polymer of said composition of said reinforcing layer (2) is a thermosetting polymer.

The thermosetting polymers are selected from epoxide resins, polyesters and polyurethanes, in particular epoxide or epoxide-based resins.

Advantageously, said at least one predominant thermosetting polymer is present at more than 60% by weight, especially at more than 70% by weight, particularly at more than 80% by weight, more particularly greater than or equal to 90% by weight, relative to the total weight of the composition.

Said composition may further comprise impact modifiers and/or additives.

The additives may be selected from an antioxidant, a heat stabilizer, a UV absorber, a light stabilizer, a lubricant, an inorganic filler, an inorganic filler, a flame retardant, a nucleating agent, a plasticizer, a pigment and a dye.

Advantageously, said composition consists of said predominant thermosetting polymer in at least 90% by weight, from 0 to 5% by weight of impact modifier, from 0 to 5% by weight of additives, the sum of the constituents of the composition being equal to 100%. Advantageously, said composition consists of said predominant thermosetting polymer in at least 90% by weight, from 1 to 5% by weight of impact modifier, from 0.1 to 5% by weight of additives, the sum of the constituents of the composition being equal to 100%. Said at least one predominant thermosetting polymer in each layer may be the same or different.

### Regarding the Structure

Said multilayer structure thus comprises a sealing layer and at least one composite reinforcing layer which may be welded together or not.

In a first variant of said structure, said sealing layer (1) and the innermost composite reinforcing layer are not welded together.

Said sealing layer (1) therefore consists of a composition predominantly comprising polychlorotrifluoroethylene (PCTFE), and at least one of said innermost composite reinforcing layers is made up of a fibrous material in the form of continuous fibers impregnated with a composition predominantly comprising at least one thermoplastic polymer as defined above or a thermosetting polymer as defined above.

In one advantageous embodiment, said multilayer structure comprises a single sealing layer and a single composite reinforcing layer which are not welded together, said sealing layer being in contact with the liquid hydrogen.

In a second variant of said structure, said sealing layer (1) and the innermost composite reinforcing layer are welded together.

In one embodiment of this second variant, said polymer of said composition of said reinforcing layer (2) is a thermoplastic polymer, said polymer P2 of each composite reinforcing layer is partially or totally miscible with polymer P2 of the adjacent composite reinforcing layer, said PCTFE polymer of each sealing layer (1) is partially or totally miscible with polymer P2 of the adjacent composite reinforcing layer, the total or partial miscibility of the said polymers being defined by the difference in glass transition temperature of the PCTFE and polymer P2 in the mixture, with respect to the difference in glass transition temperature of the PCTFE and polymer P2, before the mixture, and the miscibility being total when said difference is equal to 0, and the miscibility being partial, when said difference is different from 0, a total immiscibility between each polymer P2 or between P2 and PCTFE being excluded.

Miscibility is partial when said difference in glass transition temperature of each polymer P2 constituting the different composite reinforcing layers or between P2 and the PCTFE predominantly composing the liner, in the mixture, is less in absolute value than said difference in glass transition temperature of each polymer P2 or of the polymer P2 and of the PCTFE, before mixing.

When the miscibility of said polymers is partial, said miscibility is even greater when said difference in glass transition temperature of each polymer P2 or between P2 and the PCTFE in the mixture is low.

Advantageously, when the miscibility of said polymers is partial, said difference in glass transition temperature of each polymer P2 or between P2 and the PCTFE, in the mixture, relative to the difference in glass transition temperature of each polymer P2 or between P2 and the PCTFE before the mixture is less than 30%, preferably less than 20%, in absolute value.

In one embodiment, the glass transition temperature(s) of the mixture, depending on whether the miscibility is full or partial, which must be between, and different from, the glass transition temperatures of said polymers prior to blending, are at least 5° C., preferably at least 10° C.

The expression “fully miscible” means that when, for example, two polymers P1₁ and P1₂ having respectively a Tg1₁ and a Tg1₂ are present, respectively, in two adjacent sealing layers or two adjacent reinforcing layers, then the mixture of the two polymers has only one Tg1₁1₂, the value of which is between Tg1₁ and a Tg1₂.

This Tg1₁1₂ value is then greater than Tg1₁ by at least 5° C., in particular by at least 10° C. and lower than Tg1₂ by at least 5° C., in particular by at least 10° C.

The expression “partially miscible” means that when, for example, two polymers P1₁ and P1₂ having respectively a Tg1₁ and a Tg1₂ are present, respectively, in two adjacent sealing layers or two adjacent reinforcing layers, then the mixture of the two polymers has two Tgs: Tg′1₁ and Tg′1₂, where Tg1₁<Tg′1₁<Tg′1₂<Tg1₂. These Tg′1₁ and Tg′1₂ values are then greater than Tg1₁ by at least 5° C., in particular by at least 10° C. and lower than Tg1₂ by at least 5° C., in particular by at least 10° C.

An immiscibility of two polymers results in the presence of two Tgs, Tg1₁ and Tg1₂, in the mixture of the two polymers which correspond to the respective Tgs, Tg1₁ and Tg1₂, of the pure polymers taken separately.

Advantageously, said welded sealing and reinforcing layers are made of compositions which respectively comprise different polymers.

Nevertheless, said different polymers may be of the same type.

Said multilayer structure comprises one sealing layer and may comprise up to 10 composite reinforcing layers.

Advantageously, said multilayer structure comprises one sealing layer and one, two, three, four, five, six, seven, eight, nine or ten composite reinforcement layers. Advantageously, said multilayer structure comprises one sealing layer and one, two, three, four or five composite reinforcement layers.

Advantageously, said multilayer structure comprises one sealing layer and one, two or three composite reinforcing layers.

Advantageously, they consist of compositions which respectively comprise different polymers.

Advantageously, the polymer of the layer of the composition of the composite reinforcing layer (2) is chosen from polyvinylidene fluoride (PVDF), an epoxide or epoxide-based resin, poly (methyl methacrylate) (PMMA) or PCTFE.

Advantageously, the polymer of the layer of the composition of the composite reinforcing layer (2) is PCTFE.

In one embodiment, said multilayer structure comprises a single sealing layer and several reinforcing layers, said sealing layer being welded to said adjacent reinforcing layer.

In one advantageous embodiment, said multilayer structure comprises a single sealing layer and a single composite reinforcing layer which are welded together, said sealing layer being in contact with the liquid hydrogen.

All combinations of these two layers are therefore within the scope of the invention, provided that at least said innermost composite reinforcing layer is welded to said outermost adjacent sealing layer.

In another embodiment of this second variant, said polymer of said composition of said reinforcing layer (2) is a thermosetting polymer as defined above.

In a third variant, said structure, said sealing layer (1) and said at least one innermost composite reinforcing layer are welded and said sealing layer (1) consists of a fibrous material in the form of continuous fibers impregnated with a composition predominantly comprising polychlorotrifluoroethylene (PCTFE) and at least one of said innermost composite reinforcing layers consisting of a fibrous material in the form of continuous fibers impregnated with a composition predominantly comprising at least one thermoplastic polymer which is PCTFE.

Advantageously, in this third variant, all the composite reinforcing layers consist of a fibrous material in the form of continuous fibers impregnated with a composition predominantly comprising at least one thermoplastic polymer which is PCTFE.

In one embodiment of one of the three variants of the structure, said structure further comprises at least one insulating outer layer (3), said insulating layer being the outermost layer of said structure.

The insulation can be carried out by an insulating outer layer based on rock wool. It can also be carried out by a metal insulating outer layer (3), by creating a vacuum in the space that exists between said metal outer layer (3) and said second layer (2).

This vacuumization can be carried out according to the methods known to a person skilled in the art. Said metal insulating outer layer may be made of aluminum.

In yet another embodiment, said structure further comprises at least one metal layer (3′), in particular made of aluminum in contact with the composite reinforcement, in order to make the tank impermeable to hydrogen and therefore to preserve the vacuum in the event of a metal insulating outer layer (3) being present.

Advantageously, said structure further comprises at least one insulating outer layer (3), said insulating outer layer (3) being the outermost layer of said multilayer structure.

The insulation can be carried out by an insulating outer layer based on rock wool.

It can also be carried out by a metal insulating outer layer (3), by creating a vacuum in the space that exists between said metal layer (3′) and said metal insulating outer layer (3).

In one embodiment of one of the three variants of the structure, hydrogen is liquid inside said sealing layer.

Advantageously, the pressure of the liquid hydrogen inside said sealing layer is from 0.08 bar to 100 bar and the temperature of the liquid hydrogen is between 13.7° K and 33° K. The definition of the zone of the phase diagram of hydrogen and in particular the delimitation of its liquid zone in the phase diagram (P, t) is known to the person skilled in the art and is in particular represented in the thesis by Mounir Sahli (Synthese, elaboration et caractérisation des nanocomposites à base de magnesium pour le stockage solide d′hydrogène, 2015).

In this embodiment, the presence of an insulating outer layer (3) defined above is then necessary to allow hydrogen to remain in liquid form. In another embodiment of one of the three variants of the structure, hydrogen is biphasic liquid/gas inside said sealing layer.

Advantageously, in this embodiment, the pressure of hydrogen inside said sealing layer is from 20 bars to 900 bars, preferably from 20 to 400 bars depending on the temperature at which the hydrogen is located in this sealing layer; at a maximum temperature of 230K.

In this embodiment, said insulating outer layer (3) defined above is not necessarily a metal insulating outer layer, by creating a vacuum in the space that exists between said metal outer layer and said metal insulating outer layer, which leads to heating of the hydrogen during its use, thereby taking it from the liquid phase to the gas phase with an increase in pressure possibly up to 900 bars, in particular when the hydrogen temperature reaches 230K.

In another embodiment, said structure is a tank.

In yet another embodiment, said structure is a pipe or tube.

Advantageously, said structure is a pipe or tube comprising end fittings that make it possible to assemble a plurality of pipes or tubes to one another in a sealed manner and/or to close them.

### Regarding the Fibrous Material

Regarding the fibers making up said fibrous material, they are in particular mineral, organic or plant fibers.

Advantageously, said fibrous material may be sized or unsized.

Said fibrous material can therefore comprise up to 1.5% by weight of an organic material (of thermosetting or thermoplastic resin type), referred to as sizing.

The mineral fibers include carbon fibers, glass fibers, basalt or basalt-based fibers, silica fibers, or silicon carbide fibers, for example. The organic fibers include thermoplastic or thermosetting polymer-based fibers, such as semi-aromatic polyamide fibers, aramid fibers or polyolefin fibers, for example. Preferably, they are amorphous thermoplastic polymer-based and have a glass transition temperature Tg higher than the Tg of the polymer or thermoplastic polymer mixture constituting the pre-impregnation matrix when the latter is amorphous, or higher than the Tm of the polymer or thermoplastic polymer mixture constituting the pre-impregnation matrix when the latter is semi-crystalline. Advantageously, they are semi-crystalline thermoplastic polymer-based and have a melting temperature Tm higher than the Tg of the polymer or thermoplastic polymer mixture constituting the pre-impregnation matrix when the latter is amorphous, or higher than the Tm of the polymer or thermoplastic polymer mixture constituting the pre-impregnation matrix when the latter is semi-crystalline. Thus, there is no melting risk for the organic fibers constituting the fibrous material during the impregnation by the thermoplastic matrix of the final composite. The plant fibers include natural linen, hemp, lignin, bamboo, silk, in particular spider silk, sisal, and other cellulose-based fibers, in particular viscose-based. These plant fibers can be used pure, treated or coated with a coating layer, in order to facilitate the adherence and impregnation of the thermoplastic polymer matrix.

The fibrous material may also be a fabric, a braided or woven with fibers.

It may also correspond to fibers with support threads.

These component fibers may be used alone or in mixtures. Thus, organic fibers may be mixed with the mineral fibers to be pre-impregnated with thermoplastic polymer powder and to form the pre-impregnated fibrous material.

The organic fiber strands may have several grammages. They can further have several geometries. The component fibers of the fibrous material can further assume the form of a mixture of these reinforcing fibers with different geometries. The fibers are continuous fibers.

The fibrous material is preferably selected from carbon fibers, glass fibers, basalt fibers and basalt-based fibers.

Preferably, the fibrous material consists of continuous carbon or glass fibers or or mixtures thereof, in particular carbon fibers. It is used in the form of a strand or several strands.

### Method for Preparing the Fibrous Material

The composite reinforcing layer made up of a fibrous material in the form of continuous fibers impregnated with a composition predominantly comprising at least one thermoplastic or thermosetting polymer P2 can be prepared according to the methods well known to a person skilled in the art.

The impregnated fibrous material, in particular single-layer material, can be prepared in two steps:
a first step of pre-impregnation by a polymer matrix and
a second step of heating by means of at least one supporting part (E) and at least one heating system.

### First Step: Pre-Impregnation

The first step of pre-impregnation to obtain a material can be carried out according to techniques well known to the person skilled in the art and in particular selected from those described below.

Thus they can be carried out by a pre-impregnation technology by powder deposition, by molten route, in particular by pultrusion, by cross-head extrusion of molten polymer, by continuous passage of the fibers in an aqueous polymer powder dispersion or aqueous polymer particle dispersion or aqueous polymer emulsion or suspension, by fluidized bed, equipped or not with at least one supporter (E′), by spraying by nozzle or spray gun by dry route in a tank equipped or not equipped with at least one supporter (E′).

This first step is described in international application WO 2018/234436 and in particular by:

### Molten Route:

The pre-impregnation step can be carried out by molten route, in particular by pultrusion. Pre-impregnation techniques by molten route are known by those skilled in the art and are described in the references above.

The pre-impregnation step is carried out in particular by cross-head extrusion of the polymer matrix and passage of said roving(s) into this crosshead and then passage into a heated die, the crosshead optionally being provided with fixed or rotating supporters on which the roving passes, thus causing a spreading of said roving, enabling pre-impregnation of said roving.

The pre-impregnation can in particular be carried out as described in US 2014/0005331A1, with the difference that supplying the resin is carried out on two sides of said roving and there is no contact surface eliminating a portion of the resin on one of the two surfaces.

Advantageously, the pre-impregnation step is carried out by molten route at a high speed, that is to say, with a passage speed of said roving(s) greater than or equal to 5 m/min, in particular greater than 9 m/min.

### Fluidized Bed:

The pre-impregnation step can be carried out in fluidized bed.

An example unit for carrying out a manufacturing method without the heating step using at least one supporting part is also described in international application WO 2015/121583.

This system describes the use of a tank comprising a fluidized bed for performing the pre-impregnation step and can be used in the context of the invention.

### Spraying by Spray Gun:

The step of pre-impregnation of the fibrous material can also be carried out by sending one or more rovings into a device for continuous pre-impregnation by spraying that comprises a tank comprising one or more nozzle(s) or one or more gun(s) spraying the polymer powder on the fibrous material at the roller entry.

### Second Step: Heating

This second step is also described in international application WO 2018/234436 and in particular by means of a heating system provided with at least one supporting part (E) is present after the pre-impregnation step

According to another aspect, the present invention relates to a method for producing a structure as defined above, characterized in that it comprises a step of preparing the sealing layer (1) by extrusion, in particular molding extrusion, blow molding, compression molding, compression extrusion, injection molding and/or film deposition.

Said method applies for the first and second variants of the structure defined above.

Advantageously, for the method for preparing these first and second variants of the structure, a step of preparing the two half-parts of the sealing layer (1) by extrusion in sheet form of each half-part is carried out, then a step of thermoforming each half-part and welding together of each half-part are carried out.

This method relates both to the half-parts of a tank and to a pipe or a tube.

In one embodiment, for the method for preparing these first and second variants of the structure, said method further comprises a step of winding said composite reinforcing layer (2) around said sealing layer (1) or a step of welding said composite reinforcing layer (2) to said sealing layer (1).

Advantageously, the winding step is carried out by filament winding. Advantageously, the welding step is carried out by a system selected from laser, infrared (IR) heating, nitrogen torch, LED UV heating, induction or microwave heating or high frequency (HF) heating.

Optionally, a step of extruding said sealing layer (1) onto a metallic carcass may be carried out before the step of welding the reinforcing layer onto the sealing layer.

For the third variant of the structure, the sealing layer (1) in the form of a PCTFE-based fibrous material (Voltalef® for example) and said PCTFE-based composite reinforcing layer (2) (Voltalef® for example) can be prepared by filament winding, using one or more heating methods defined above.

In one embodiment, said method for preparing the three variants of the structure further comprises a step of manufacturing the insulating outer layer (3) over said outermost composite reinforcing layer (2).

The insulating outer layer (3) may be based on rock wool.

It can also be a metal insulating outer layer (3), by creating a vacuum in the space that exists between said metal outer layer and said second layer (2).

This vacuumization can be carried out according to the methods known to a person skilled in the art. Said outer layer may be made of aluminum.

In yet another embodiment, said method for preparing the three variants of the structure additionally comprises the manufacture of at least one metal layer (3′), in particular made of aluminum, directly in contact with said second composite reinforcing layer (2).

Advantageously, said method for preparing the three variants of the structure additionally comprises the manufacture of a metal insulating outer layer, said insulating outer layer being the outermost layer of said structure.

The insulation can be carried out by an insulating outer layer based on rock wool. It can also be carried out by a metal insulating outer layer, by creating a vacuum in the space that exists between said metal outer layer and said metal insulating outer layer.

According to another aspect, the present invention relates to an article comprising at least two pipes or tubes assembled by end pieces as defined above.

### EXAMPLE EMBODIMENTS

Example 1: Preparation of a tank with a sealing layer made of PCTFE manufactured by extrusion/coating of film by winding and then winding a carbon/Elium® composite on the sealing layer.

### Preparation of a Sealing Layer (Liner) Made of PCTFE

Material: Preparation of a VOLTALEF® 302 PCTFE-based sealing layer (Arkema).

### Hardware

The extruders are conventional with a length/diameter ratio of the screw (L/D) of 20 to 25. The compression ratio is 2.5 to 3. The speed of rotation must be able to be adjusted from 2 revolutions/minute.

The extrusion parameters used to manufacture the films in Voltalef® in the context of this example are the following:

TABLE 1

| | Thickness of the film (μm) | 100 | |
|---|---|---|---|
| Extrusion dimensions | Hastelloy C276 conical screw | 25 | |
| | diameter (mm) | | |
| | L/D | 20 | |
| | Compression rate | 3 | |
| | Hastelloy die width (mm) | 200 | |
| | Opening of the die (mm) | 0.5 | |
| | Diameter of polished stainless | 117 | |
| | steel cooling roll (mm) | | |
| Temperatures | Water entering the cylinder | 17° | C. |
| | Middle of cylinder | 285° | C. |
| | Outlet of cylinder | 300° | C. |
| | Head | 310° | C. |
| | Die | 315° | C. |
| | Cooling roll water | 17° | C. |

| | | |
|---|---|---|
| Speed | Screw speed (rpm) | 12 |
| | Torque (kg/m) | 0.75 |
| | Melting pressure (kg/cm²) | 240 |
| | Tensile speed (m/min) | 0.38 |

The film thus obtained is then wound on a mandrel to form the sealing layer.

In our example 1, the sealing layer takes the form of a tubular tank with two domes at its ends, with a diameter of 30 cm and a total length of 1 m.

Preparation of a Tank with Sealing Layer of PCTFE and Elium® Composite

Once the sealing layer is made from Voltalef® 302 (Arkema) as previously described, the reinforcing layer is manufactured by filamentary winding of carbon/Elium® prepregs. In this example, 24 k carbon fibers from SGL (reference Sigrafil® C T 24-5.0/270-V100) sized vinyl ester are used, or a sizing that is perfectly compatible with the Elium® resin. 4 reels of carbon fibers are placed on a reel. They are then unwound while maintaining a controlled mechanical tension at the outlet of the reel, then pass into an Elium® resin bath for being expanded and pre-impregnated. In this example, the impregnated Elium® resin content is controlled by adapting the height of the resin bath wherein the fibers soak and by regulating the rate of passage in that bath, and thus the residence time in the bath. The run speed in the bath is the same as the filament winding speed and is 1 m/s.

The Elium® resin used in this example comprises two types of polymerization initiators, one being photosensitive, the other being heat-sensitive. The resin is then pre-polymerized using UV LEDs and UV lamps just before the roving is in contact with the liner in Voltalef®. The degree of polymerization of the resin and therefore its viscosity is controlled, a parameter important so that the resin does not to flow too much but is sufficiently fluid to be able to impregnate the carbon fibers and allow adhesion between the different layers of this reinforcement multilayer. Pre-polymerization continues with UV tubes placed around the tank during manufacture to achieve a higher degree of conversion of the resin.

Very advantageously, this (exothermic) pre-polymerization step generates only little heat, making it possible not to heat the liner in Voltalef® and therefore to keep all of its properties unchanged. In this example, the polymerization of the composite reinforcing layers is completed in an oven at the polymerization being possible thanks to the heat-sensitive initiator.

### Example 2: Production of a Liner by Injection Molding Voltalef® 302 (Arkema)

Hardware: an injection press is used to produce two half-shells of half-cylindrical shape. The injection parameters are as follows:

The material used must withstand corrosion and is made of (Hastelloy® B or C or Xalloy® 306); here Hastelloy® C.

The temperatures used in the method are as follows:
Entering the cylinder: 260-280° C.
Middle of cylinder 270-295° C.
Outlet of cylinder: 280-315° C.
Nozzle: 315-350° C.
Mold: 50-150° C.

The two half-shells are then welded together to produce the sealing layer in its final form. In this case, it takes the form of a tubular tank with two domes at the ends thereof, with a diameter of 30 cm and a total length of 1 m.

The production of the tank is done by filamentary winding of Carbon/PVDF tapes around this sealing layer. The PVDF used is a formulation based on Kynar 710 and comprising 80% of this resin and 20% of Kynar ADX 720 which is a PVDF grafted with maleic anhydride. The fiber used is the Hyoung 24 k H2550 carbon fiber and the deposition of the tapes is done by means of an AFPT robotic machine, equipped with a laser heating, at the deposition rate of 12 m/min.

The partial miscibility of the Kynar® 710 and VOLTALEF® PVDF leads to a welding of the composite reinforcement on the liner, making it possible to make a type V tank.

1. A multilayer structure which is chosen from among a tank, a pipe or a tube and configured for transporting, distributing or storing liquid hydrogen, the structure comprising a sealing layer in contact with the liquid hydrogen, the sealing layer comprising a composition which comprises a polymer P1 which is polychlorotrifluoroethylene and at least one second layer located above the sealing layer,
the second layer being a composite reinforcing layer consisting of a fibrous material in the form of continuous fibers impregnated with a composition mainly comprising at least one thermoplastic or thermosetting polymer P2.

2. The multilayer structure according to claim 1, wherein said sealing layer is made up of a fibrous material in the form of continuous fibers impregnated with a composition predominantly comprising polychlorotrifluoroethylene and at least one of said innermost composite reinforcing layers consisting of a fibrous material in the form of continuous fibers impregnated with a composition predominantly comprising at least one thermoplastic polymer which is PCTFE.

3. The multilayer structure according to claim 1, wherein said innermost composite reinforcing layer is wound around said sealing layer,
said sealing layer consisting of a composition predominantly comprising polychlorotrifluoroethylene,
and at least one of said innermost composite reinforcing layers consisting of a fibrous material in the form of continuous fibers impregnated with a composition predominantly comprising at least one thermoplastic or thermosetting polymer.

4. The multilayer structure according to claim 3, wherein said polymer of said composition of said reinforcing layer is a thermoplastic polymer.

5. The multilayer structure according to claim 4, wherein said innermost composite reinforcing layer is welded or not to said sealing layer.

6. The multilayer structure according to claim 4, wherein said polymer of said composition of said reinforcing layer is a thermoplastic polymer,
said polymer P2 of each composite reinforcing layer is partially or totally miscible with polymer P2 of the adjacent composite reinforcing layer,
said PCTFE polymer of each sealing layer is partially or totally miscible with polymer P2 of the adjacent composite reinforcing layer,
the total or partial miscibility of the said polymers being defined by the difference in glass transition temperature of the PCTFE and polymer P2 in the mixture, with respect to the difference in glass transition temperature of the PCTFE and polymer P2, before the mixture, and the miscibility being total when said difference is equal to 0, and the miscibility being partial, when said difference is different from and total immiscibility between each polymer P2 or between P2 and PCTFE being excluded.

7. The structure according to claim 4, wherein said thermoplastic polymer P2 of said composition of said reinforcing layer is PCTFE.

8. The multilayer structure according to claim 3, wherein said polymer of said composition of said reinforcing layer is a thermosetting polymer.

9. The multilayer structure according to claim 3, wherein it comprises from inside to outside a single sealing layer and a single reinforcing layer, said sealing layer being in contact with the liquid hydrogen.

10. The multilayer structure according to claim 1, wherein hydrogen is liquid inside said sealing layer.

11. The multilayer structure according to claim 10, wherein the pressure of the liquid hydrogen inside said sealing layer is from 0.08 bar to 100 bar and the temperature of the liquid hydrogen is between 13.7° K and 33° K.

12. The multilayer structure according to claim 1, wherein said structure is a tank.

13. The multilayer structure according to claim 1, wherein said structure is a pipe or tube.

14. The multilayer structure according to claim 13, wherein structure is a pipe or tube comprising end fittings that make it possible to assemble a plurality of pipes or tubes to one another in a sealed manner and/or to close them.

15. The multilayer structure according to claim 1, wherein said sealing layer further comprises additives, enabling them to absorb radiation suitable for welding.

16. The multilayer structure according to claim 1, wherein said reinforcing layer further comprises additives, enabling them to absorb radiation suitable for welding.

17. The multilayer structure according to claim 16, wherein said composition is transparent to radiation suitable for welding.

18. The multilayer structure according to claim 15, wherein the welding is carried out by a system selected from laser, infrared heating, nitrogen torch, LED UV heating, induction or microwave heating or high frequency heating.

19. The multilayer structure according to claim 1, wherein said structure further comprises at least one insulating outer layer, said layer being the outermost layer of said structure.

20. The multilayer structure according to claim 1, wherein the fibrous material is selected from glass fibers, carbon fibers, and basalt fibers or basalt-based fibers.

21. A method for producing a structure as defined according to claim 1, where in it comprises a step of preparing the sealing layer by extrusion, blow molding, compression molding, compression extrusion, injection molding and/or film deposition.

22. The method according to claim 21, wherein it comprises a step of winding said composite reinforcing layer around said sealing layer or a step of welding said composite reinforcing layer to said sealing layer.

23. The method according to claim 22, wherein the step of welding is carried out by filament winding.

24. The method according to claim 22, wherein the step of welding is carried out by a system selected from laser, infrared heating, nitrogen torch, LED UV heating, induction or microwave heating or high frequency heating.

25. The method according to claim 1, wherein it further comprises a step of manufacturing the insulating outer layer over said outermost composite reinforcing layer.

26. An article comprising at least two pipes or tubes assembled by end pieces as defined in claim 14.
